(19) United States
(12) Patent Application Publication
(10) Pub. No.: US 2003/0164618 A1
(43) Pub. Date: Sep. 4, 2003

(54) Energy-absorbing elements for automobile bumpers and methods of making the same

(76) Inventor: Derek Gentle, Essex (GB)

Correspondence Address: BANNER & WITCOFF, LTD., TEN SOUTH WACKER DRIVE, SUITE 3000, CHICAGO, IL, 60606, US

(21) Appl. No.: 10/148,316

(22) PCT Filed: Nov. 29, 2000
(86) PCT No.: PCT/US00/42326

(30) Foreign Application Priority Data
Nov. 29, 1999 (US) 60167805

(51) Int. Cl. B60R 19/02

(52) U.S. Cl. 293/102

(57) ABSTRACT

An energy-absorbing element for absorbing impact in a vehicle bumper has a plurality of independently deformable sections so as to reduce the impact imparted to an object. The invention also relates to a process of manufacturing a vehicle bumper that includes the steps of providing an energy-absorbing element including a plurality of independently deformable sections so as to reduce the impact imparted to an object; and incorporating the energy-absorbing element into a vehicle bumper.

### FIELD OF THE INVENTION

The present invention relates generally to bumper elements for automobiles and methods for manufacturing the same. Specifically, the invention relates to automobile bumpers that incorporate energy-absorbing elements for pedestrian safety.

### BACKGROUND OF THE INVENTION

Much effort has been invested in the design and manufacture of automobile bumpers with a view towards providing increased safety to pedestrians. Such designs typically anticipate relatively low speed impacts, on the order of 5 miles per hour, and seek to reduce the injury to pedestrians who might experience such low speed impacts. Typical bumpers incorporate inserts molded energy-absorbing foam such as polyurethane or EPP (expanded polypropylene) with a generally continuous planar impact face.

Constant efforts are being made to improve the impact characteristics of vehicle bumpers in order to improve pedestrian safety. Accordingly, it would be advantageous to provide an energy-absorbing element for automobile bumpers which reduces the likelihood of injury to a pedestrian impacted by an automobile at low speeds. It would further be advantageous to provide a method for making such an energy-absorbing element.

### SUMMARY OF THE INVENTION

The aforementioned desired advantages are realized by the present invention, which contemplates a new and improved energy-absorbing insert for automobile bumpers and methods of making the same.

An insert according to the invention is provided with several discrete independently-deforming columns or sections of energy-absorbing foam. The presence of the discrete sections reduces the beam effect of the energy-absorbing element upon impact and therefore reduces the impact forces imparted to a struck pedestrian or other object.

The invention also provides a method of making an energy-absorbing element which includes the steps of providing an energy-absorbing element, forming discrete sections in the energy-absorbing element and incorporating the energy-absorbing element into a bumper construction.

### BRIEF DESCRIPTIONS OF THE DRAWINGS

The accompanying drawings which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings, in which like numbers refer to like parts throughout:

FIG. 1 is a top sectional view of a bumper incorporating an energy-absorbing element according to the present invention;

FIG. 2 is a force-deflection curve of an energy-absorbing element according to the present invention;

FIG. 3 is a force-deflection curve of a non-sectioned energy-absorbing element according to the prior art;

FIG. 4 is top sectional view of a bumper incorporating an energy-absorbing element according to a second embodiment of the present invention.

### DESCRIPTION OF THE PREFERRED EMBODIMENT

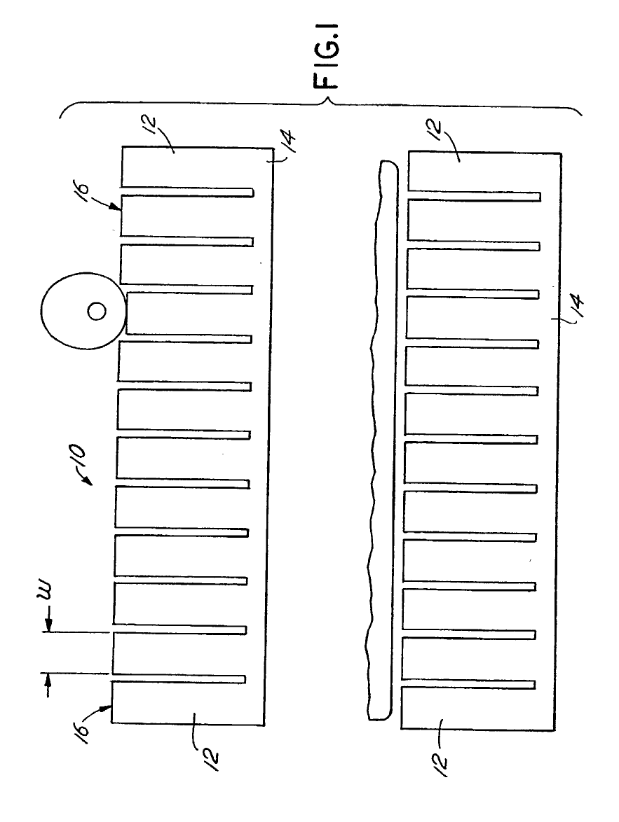

FIG. 1 illustrates a top sectional view of an energy-absorbing element 10 according to the present invention. As can be seen, energy-absorbing element 10 includes a plurality of sections or columns 12, each depending from a common base 14. Sections or columns 12 generally rectangular in cross-section and preferably have a transverse width (W) of about 4-5 cm (about 2 inches). However, although not illustrated, impact surfaces 16 may be contoured to conform to a particular bumper design. The energy-absorbing element is preferably formed from a foam material, namely polyurethane foam or expanded polypropylene (EPP).

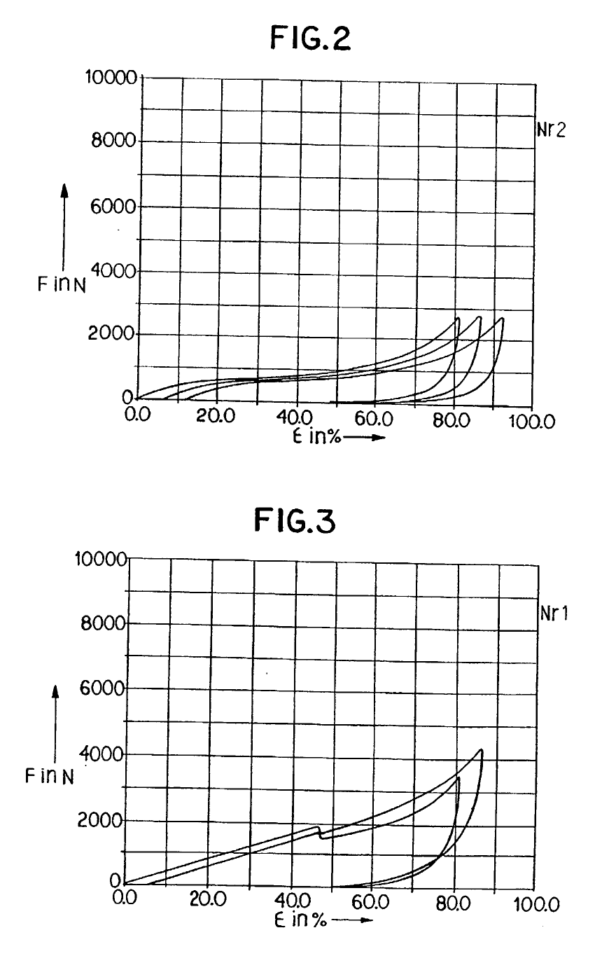

FIG. 2 illustrates a force-deflection curve that is characterisic of an energy-absorbing element according to the invention. FIG. 3 illustrates a force-deflection curve that is characteristic of an energy-absorbing element according to the prior art. As can be seen, the present invention provides a substantially flat force-deflection curve, with a force of about 1000 N for a deflection range from 20-percent to 60-percent.

In contrast, energy-absorbing elements according to the prior art provide a substantially linear force-deflection curve, with the force rising from 1000 N to 2000 N for a deflection range from 20-percent to 60-percent.

Sections 12 provided in the energy-absorbing element 10 according to the present invention reduce the beam effect of the overall energy-absorbing element structure. In prior art energy-absorbing elements, the impact face is typically a single continuous surface. Deflection of the impact face results in surface tension forces, and therefore an increased impact force on the object causing the deflection. Sectioning of the energy-absorbing element according to the invention substantially eliminates the beam effect of prior art elements. Thus, the reactionary force exerted on an object is reduced for a given deflection of the element. Moreover, the reactionary force does not increase substantially with increasing deflection.

The invention also contemplates methods of making energy-absorbing elements for vehicle bumpers. In a first embodiment of the method, the sections 12 and common base 14 are molded directly as a unit. A first half of the mold has a complementary surface to the plurality of sections 12. A second half of the mold has a surface complementary to the common base 14. The mold halves are closed together defining a mold cavity, into which the polyurethane foam or EPP is injected and allowed to expand and cure in a manner well known in the art.

Alternatively, a solid block of polyurethane foam or EPP could be prepared and then a front face is cut to remove thin slices, thereby defining the sections 12.

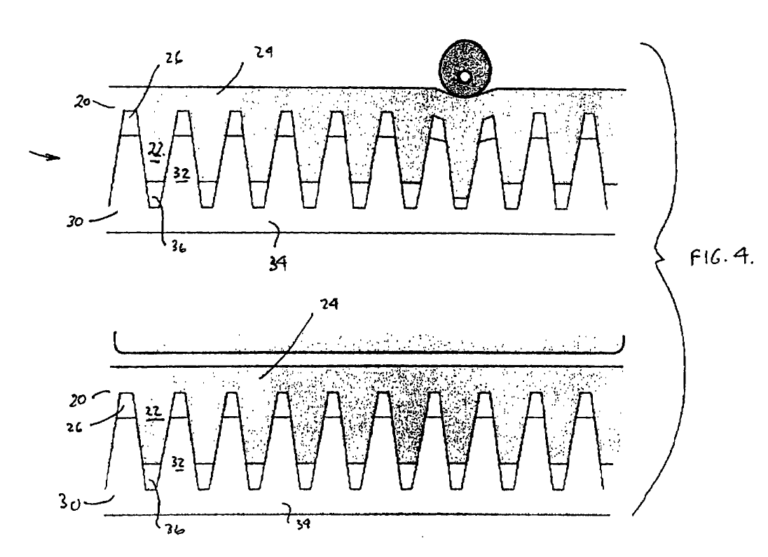

FIG. 4 illustrates a top sectional view of a bumper having an energy-absorbing elements 20, 30 of a second embodiment of the present invention. The energy-absorbing elements 20, 30 are similar to the energy-absorbing element 10 of the first embodiment except that the sections 22, 32 are triangularly or wedge shaped extending from a common base 24, 34. The two energy-absorbing elements 20, 30 are positioned in a face to face manner such that the opposing sections 22, 32 interlock. The interlock in not full, in that air gaps 26, 36 are present.

On impact, the opposing sections 22, 32 will increase engagement between the angled faces of the sections 22, 32 and close the air gaps 26, 36.

Although the preferred embodiments of this invention have been described hereinabove in some detail, it should be appreciated that a variety of embodiments will be readily available to persons utilizing the invention for a specific end use. The description of this invention is not intended to be limiting on this invention, but is merely illustrative of the preferred embodiment of this invention. Other products, apparatus and methods which incorporate modifications or changes to that which has been described herein are equally included within this application. Additional objects, features and advantages of the present invention will become apparent by referring to the above description of the invention in connection with the accompanying drawings.

I claim:

1. An energy-absorbing element for absorbing impact in a vehicle bumper comprising a plurality of independently deformable sections so as to reduce the impact imparted to an object.

2. An energy-absorbing element according to claim 1 wherein said plurality of independently deformable sections extend from a common base.

3. An energy-absorbing element according to claim 2 wherein said element is formed from a foam material.

4. An energy-absorbing element according to claim 3 wherein said foam material is selected from a group comprising: polyurethane or expanded polypropylene.

5. An energy-absorbing element according to claim 4 wherein said independently deformable sections are generally rectangular in cross-section.

6. An energy-absorbing element according to claim 4 wherein said independently deformable sections are generally wedge shaped.

7. An energy-absorbing system for absorbing impact in a vehicle bumper comprising a first energy-absorbing element having a plurality of independently deformable sections and a second energy-absorbing element having a plurality of independently deformable sections, said first energy-absorbing element arranged in a face to face and interlocking relation with said second energy-absorbing element.

8. An energy-absorbing system according to claim 7 wherein said first and second energy-absorbing elements are each formed from a foam material.

9. An energy-absorbing system according to claim 8 wherein said foam material is selected from a group comprising: polyurethane or expanded polypropylene.

10. An energy-absorbing system according to claim 7 wherein each of said independently deformable sections are generally wedge shaped.

11. A process of manufacturing a vehicle bumper comprising the steps of:
providing an energy-absorbing element including base and a plurality of independently deformable sections extending therefrom; and
incorporating the energy-absorbing element into the vehicle bumper.

12. A process according to claim 11 wherein said step of providing an energy-absorbing element includes a step of foaming a block of foam material and then cutting a plurality of slices from one face of said block presenting said plurality of independently deformable sections.

13. A process according to claim 11 wherein said step of providing an energy-absorbing element includes a step of integrally foaming said element.

14. A process according to claim 11 wherein said process further comprises a step of providing a second energy-absorbing element including a base and a plurality of independently deformable sections extending therefrom and interlocking respectively said plurality of independently deformable sections in a face to face relation.

15. A process according to claim 14 wherein said energy-absorbing element is a foam material selected from a group comprising: polyurethane or expanded polypropylene.

16. A process according to claim 15 wherein each of said independently deformable sections are generally wedge shaped.
